(19) United States
(12) Patent Application Publication
(10) Pub. No.: US 2020/0056832 A1
(43) Pub. Date: Feb. 20, 2020

(54) ADJUSTABLE AUXILIARY LIGHTING FOR AN APPLIANCE

(71) Applicant: Haier US Appliances Solutions, Inc., Wilmington, DE (US)

(72) Inventor: Jill Snyder, Newburgh, IN (US)

(21) Appl. No.: 16/105,012

(22) Filed: Aug. 20, 2018

(51) Int. Cl. F25D 27/00; F25D 23/12; H05B 37/02

(52) U.S. Cl. CPC F25D 27/005; F25D 23/126; F25D 2600/02; H05B 37/0245; F25D 2327/001; H05B 37/0281

(57) ABSTRACT

A method of operating a refrigerator appliance is provided. The refrigerator appliance includes a cabinet and an auxiliary light positioned on an exterior of the cabinet. The method includes determining a brightness level setting of the auxiliary light on a user interface of a remote user device and sending a signal from the remote user device to a controller of the refrigerator appliance. The controller is in operative communication with the auxiliary light. The method also includes adjusting a brightness of the auxiliary light to the determined brightness level setting with the controller of the refrigerator appliance based on the received signal.

### FIELD OF THE INVENTION

The present subject matter relates generally to appliances and more particularly to adjustable auxiliary lighting for appliances.

### BACKGROUND OF THE INVENTION

Certain appliances include auxiliary lighting assemblies operatively configured to emit light so as to improve the aesthetic appearance or ease of use of the appliance. Such auxiliary lighting assemblies may be provided, e.g., in a handle of the appliance and/or a dispenser recess of the appliance.

In some instances, a consumer may desire to change the brightness of the light emitted from the auxiliary lighting assembly of their appliance. Conventional auxiliary lighting assemblies have not provided consumers with a readily available means for changing the brightness of the emitted light.

Accordingly, an auxiliary light for an appliance that provides a variable brightness would be useful.

### BRIEF DESCRIPTION OF THE INVENTION

Aspects and advantages of the invention will be set forth in part in the following description, or may be apparent from the description, or may be learned through practice of the invention.

In one exemplary aspect, the present subject matter is directed to a method of operating a refrigerator appliance. The refrigerator appliance includes a cabinet and an auxiliary light positioned on an exterior of the cabinet. The method includes receiving a signal from a remote device and adjusting a brightness of the auxiliary light of the refrigerator appliance based on the received signal.

In another exemplary aspect, the present subject matter is directed to a method of operating a refrigerator appliance. The refrigerator appliance includes a cabinet and an auxiliary light positioned on an exterior of the cabinet. The method includes determining a brightness level setting of the auxiliary light on a user interface of a remote user device and sending a signal from the remote user device to a controller of the refrigerator appliance. The controller is in operative communication with the auxiliary light. The method also includes adjusting a brightness of the auxiliary light to the determined brightness level setting with the controller of the refrigerator appliance based on the received signal.

In yet another exemplary aspect, the present subject matter is directed to a refrigerator appliance. The refrigerator appliance includes a cabinet and a door rotatably connected to the cabinet. The refrigerator appliance also includes a handle assembly connected with or integrally formed with the door and having a handle body defining a recess. The refrigerator appliance further includes a dispenser assembly comprising a control panel and an auxiliary light. A controller of the refrigerator appliance is in operative communication with the control panel and the auxiliary light. The controller is configured for receiving a signal from a remote device and adjusting a brightness of the auxiliary light of the refrigerator appliance based on the received signal.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary refrigerator appliance according to an exemplary embodiment of the present subject matter.

FIG. 2 provides a side elevation view of one refrigerator door of the refrigerator appliance of FIG. 1 depicting a handle assembly.

FIG. 3 provides a perspective view of the exemplary handle assembly of FIG. 2.

FIG. 4 provides a cross-sectional view of doors of the exemplary refrigerator appliance of FIG. 1 in a closed configuration.

FIG. 5 provides a close up view of Section B of FIG. 4.

FIG. 6 provides a schematic illustration of an exemplary remote user interface device in communication with the exemplary refrigerator appliance of FIG. 1 according to one or more exemplary embodiments of the present subject matter.

FIG. 7 provides a view of an exemplary user interface of the remote user interface device of FIG. 6 according to one or more exemplary embodiments of the present subject matter.

FIG. 8 provides a view of an exemplary user interface of the remote user interface device of FIG. 6 according to one or more exemplary embodiments of the present subject matter.

FIG. 9 provides a flow chart of an exemplary method of operating a refrigerator appliance according to one or more exemplary embodiments of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

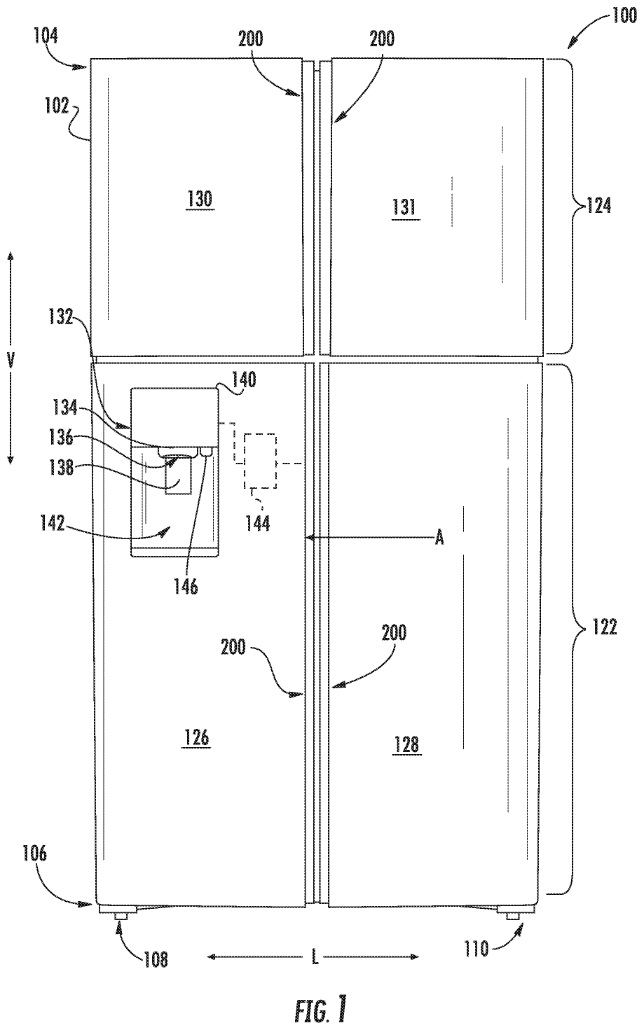

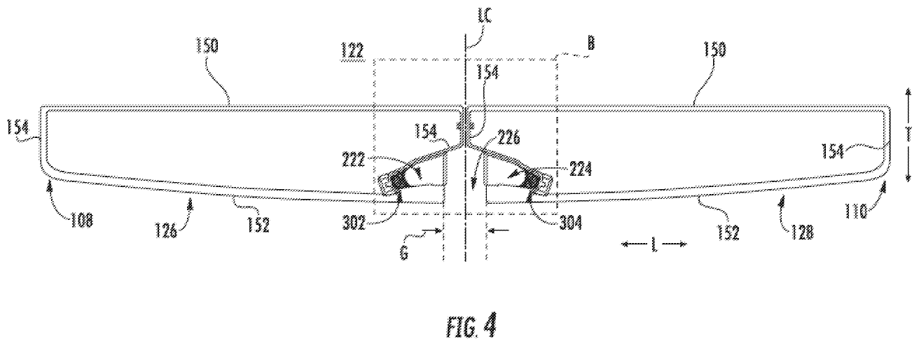

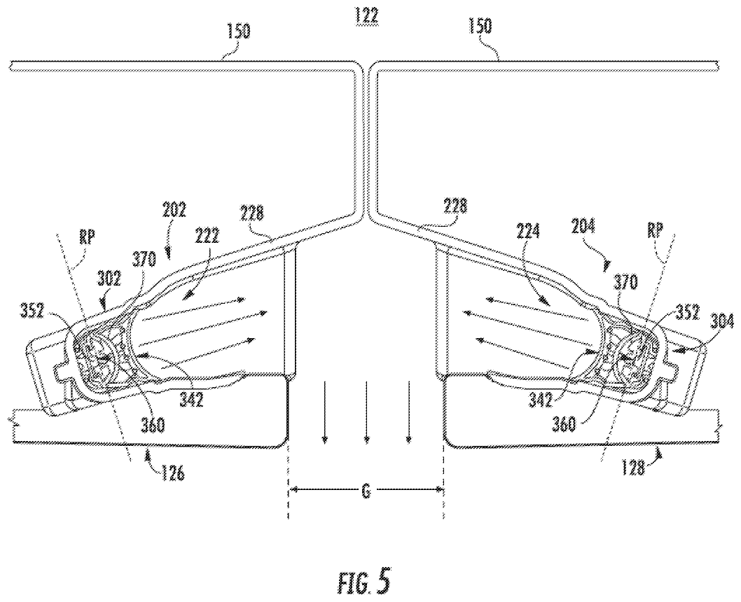

FIG. 1 provides a front view of a refrigerator appliance 100 according to an exemplary embodiment of the present subject matter. Refrigerator appliance 100 includes a housing or cabinet 102 that extends between a top 104 and a bottom 106 along a vertical direction V, between a first side 108 and a second side 110 along a lateral direction L, and between a front side and a rear side along a transverse direction T (a direction into and out of the page in FIG. 1, see also FIG. 4). Each of the vertical direction V, lateral direction L, and transverse direction T are mutually perpendicular to one another and form an orthogonal direction system.

Cabinet 102 defines chilled chambers for receipt of food items for storage. In particular, cabinet 102 defines a fresh food chamber 122 positioned at or adjacent bottom 106 of cabinet 102 and a freezer chamber 124 arranged at or adjacent top 104 of cabinet 102. As such, refrigerator appliance 100 is generally referred to as a top mount or top freezer refrigerator. It is recognized, however, that the benefits of the present disclosure apply to other types and styles of refrigerator appliances as well, such as, e.g., a bottom mount refrigerator appliance or a side-by-side style refrigerator appliance. Consequently, the description set forth herein is for illustrative purposes and is not intended to be limiting in any aspect to any particular refrigerator configuration or style. Moreover, while the present subject matter is described herein as pertaining to lighting assemblies for refrigerator appliances, the teachings and scope of the present subject matter are also applicable to other types of appliances. For example, the structure and configuration of the exemplary lighting assemblies described and illustrated herein may also be applicable to other appliances with doors and/or handles, including but not limited to washers, dryers, microwaves, freezers, ovens, etc.

Refrigerator appliance 100 can include one or more doors. For this exemplary embodiment, refrigerator appliance includes refrigerator doors and freezer doors configured in a quad door configuration. As shown in FIG. 1, refrigerator doors 126, 128 are rotatably hinged to an edge of cabinet 102 for selectively accessing fresh food chamber 122. In particular, first refrigerator door 126 is rotatably hinged to cabinet 102 proximate first side 108 and second refrigerator door 128 is rotatably hinged proximate second side 110 of refrigerator appliance 100. Similarly, freezer doors 130, 131 are rotatably hinged to an edge of cabinet 102 for selectively accessing freezer chamber 124. More specifically, for this embodiment, first freezer door 130 is rotatably hinged to cabinet 102 proximate first side 108 and second freezer door 131 is rotatably hinged proximate second side 110 of refrigerator appliance 100. To prevent leakage of cool air, refrigerator doors 126, 128, freezer doors 130, 131 and/or cabinet 102 may define one or more sealing mechanisms (e.g., rubber gaskets) at the interface where the doors 126, 128, 130, 131 meet cabinet 102. Refrigerator doors 126, 128 and freezer doors 130, 131 are shown in a closed configuration in FIG. 1. It should be appreciated that doors having a different style, position, or configuration are possible and within the scope of the present subject matter.

Refrigerator appliance 100 also includes a dispensing assembly 132 for dispensing liquid water and/or ice. Dispensing assembly 132 includes a dispenser 134 positioned on or mounted to an exterior portion of refrigerator appliance 100, e.g., on refrigerator door 126. Dispenser 134 includes a discharging outlet 136 for accessing ice and liquid water. An actuating mechanism 138, shown as a paddle, is mounted below discharging outlet 136 for operating dispenser 134. In alternative exemplary embodiments, any suitable actuating mechanism may be used to operate dispenser 134. For example, dispenser 134 can include a sensor (such as an ultrasonic sensor) or a button rather than the paddle. A control panel 140 is provided for controlling the mode of operation. For example, control panel 140 includes a plurality of user inputs (not labeled), such as a water dispensing button and an ice-dispensing button, for selecting a desired mode of operation such as crushed or non-crushed ice. For example, control panel 140 may be or include a touchscreen, where the user inputs, e.g., buttons, are defined areas on the touchscreen. The illustrated refrigerator appliance 100 further includes at least one auxiliary light positioned on an exterior of the cabinet 102, e.g., a dispenser light 146 as may be seen in FIG. 1.

Discharging outlet 136 and actuating mechanism 138 are an external part of dispenser 134 and are mounted in a dispenser recess 142. Dispenser recess 142 is positioned at a predetermined elevation convenient for a user to access ice or water and enabling the user to access ice without the need to open refrigerator doors 126, 128. In the exemplary embodiment of FIG. 1, dispenser recess 142 is positioned at a level that approximates the waist level of an adult user. According to an exemplary embodiment, the dispensing assembly 132 may receive ice from an icemaker disposed in a sub-compartment of the fresh food chamber 122 or disposed within the freezer chamber 124. The dispenser light 146 may be positioned within the dispenser recess 142 in order to illuminate the dispenser recess 142 and/or adjacent ambient environment around the exterior of the refrigerator appliance 100.

Refrigerator appliance 100 further includes a controller 144. Operation of the refrigerator appliance 100 is controlled by controller 144. In some exemplary embodiments, control panel 140 can represent a general purpose I/O (“GPIO”) device or functional block. In some exemplary embodiments, control panel 140 can include input components, such as one or more of a variety of electrical, mechanical or electro-mechanical input devices including rotary dials, push buttons, touch pads, and touch screens. Control panel 140 can be communicatively coupled with controller 144 via one or more signal lines or shared communication busses. Additionally or alternatively, control panel 140 can be communicatively coupled with controller 144 via one or more wireless connections. Control panel 140 provides selections for user manipulation of the operation of refrigerator appliance 100. In response to user manipulation of control panel 140, controller 144 operates various components of refrigerator appliance 100. For example, controller 144 is operatively coupled or in communication with various components such as one or more auxiliary lights, e.g., the dispenser light 146 described above or a handle lighting assembly, as discussed below.

Controller 144 includes memory and one or more processing devices such as microprocessors, CPUs or the like, such as general or special purpose microprocessors operable to execute programming instructions or micro-control code associated with operation of refrigerator appliance 100. The memory can represent random access memory such as DRAM, or read only memory such as ROM or FLASH. The processor executes programming instructions stored in the memory. The memory can be a separate component from the processor or can be included onboard within the processor. Alternatively, controller 144 may be constructed without using a microprocessor, e.g., using a combination of discrete analog and/or digital logic circuitry (such as switches, amplifiers, integrators, comparators, flipflops, AND gates, and the like) to perform control functionality instead of relying upon software.

With reference still to FIG. 1, each door 126, 128, 130, 131 of refrigerator appliance 100 includes a handle assembly 200 for accessing one of the chilled chambers 122, 124 of refrigerator appliance 100. For the exemplary illustrated embodiment of FIG. 1, handle assembly 200 of each door 126, 128, 130, 131 is configured as a pocket handle and each handle assembly 200 extends generally along the vertical direction V along the length of its respective door 126, 128, 130, 131 as shown. However, in some exemplary embodiments, handle assemblies 200 need not extend the length of their respective doors. For instance, handle assemblies 200 can extend along the vertical direction V over approximately half of the length of their respective doors 126, 128, 130, 131.

Various forms of pocket handles may be used to move refrigerator doors 126, 128 or freezer doors 130, 132 between an open and closed position. Pocket handles are generally integral to the door and are created by forming a recess in a door body. For example, a hand grip recess may be created on the side or front surface of a door, thereby allowing a user to manipulate the door. Pocket handles can be different sizes, depths, and locations so as to enable a user to grip the door. For example, as shown in FIG. 1, pocket handles can be used to open and close each of the pair of refrigerator doors 126, 128 or freezer doors 130, 132.

In accordance with exemplary embodiments of the present subject matter, one or more handle assemblies 200 of refrigerator appliance 100 include a handle lighting assembly operatively configured to emit light from their respective handle assemblies 200. In this way, the aesthetic appearance and ease of use of refrigerator appliance 100 can be enhanced. One or more aspects, e.g., brightness, of the light emitted from the handle assemblies 200 may be adjustable, e.g., by the controller 144.

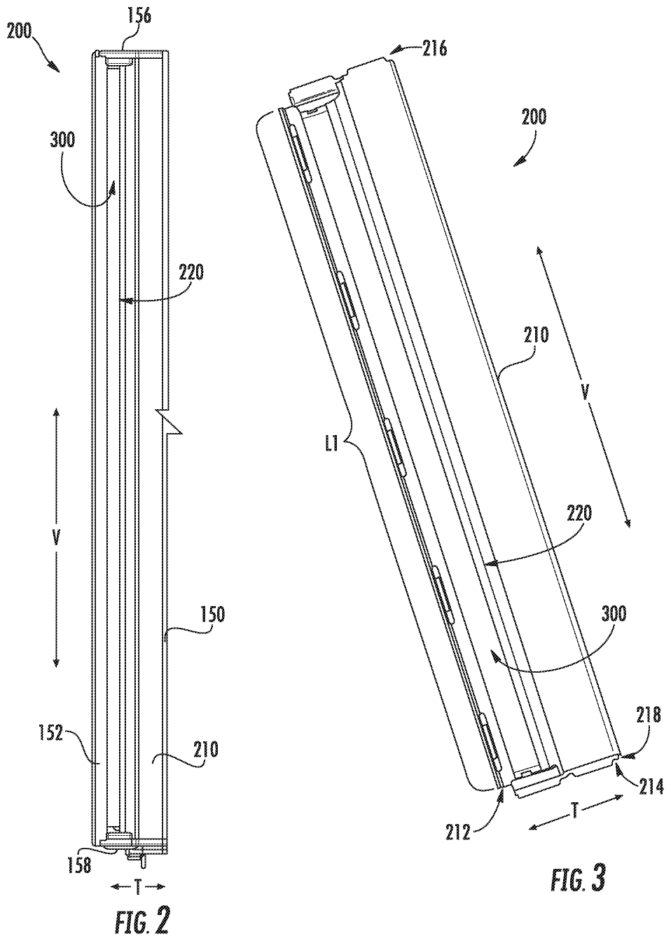

Referring now to FIGS. 2 and 3, FIG. 2 provides a side elevation view of refrigerator door 126 of the exemplary refrigerator appliance 100 of FIG. 1 depicting handle assembly 200. In particular, FIG. 2 provides a side view of handle assembly 200 of refrigerator door 126 from View A of FIG. 1. FIG. 3 provides a perspective view of handle assembly 200 thereof removed from door 126 for illustrative purposes. For this exemplary embodiment, handle assembly 200 is configured as a pocket handle, as noted above.

As shown in FIGS. 2 and 3, handle assembly 200 includes a handle body 210. Handle body 210 extends between a front 212 and a rear 214 along the transverse direction T (FIG. 3), and for this embodiment, handle body 210 is disposed between an inner wall 150 and an outer wall 152 of refrigerator door 126 (FIG. 2). Handle body 210 also extends between a top 216 and a bottom 218 along the vertical direction V (FIG. 3), and for this embodiment, handle body 210 is disposed between a top wall 156 and a bottom wall 158 of refrigerator door 126 (FIG. 2). Handle body 210 can be formed integrally with refrigerator door 126 or can be a component separate from the door. Handle body 210 defines a recess 220. Recess 220 is defined along the vertical direction V substantially along a length L1 of handle body 210 (FIG. 3). To open refrigerator door 126, a user can reach into recess 220 and can pull refrigerator door 126 open.

As further shown in FIGS. 2 and 3, handle assembly 200 includes a handle lighting assembly 300 connected to handle body 210. In particular, for this embodiment, handle lighting assembly 300 is disposed within recess 220 defined by handle body 210. In alternative exemplary embodiments, handle lighting assembly 300 can be formed integrally with handle body 210. Moreover, for this embodiment, handle lighting assembly 300 extends substantially along the length L1 of handle body 210. In alternative embodiments, handle lighting assembly 300 need not extend substantially along the length L1 of handle body 210. For instance, handle lighting assembly 300 can extend half the length L1 of handle body 210.

FIG. 4 provides a cross-sectional view of refrigerator doors 126, 128 of the exemplary refrigerator appliance 100 of FIG. 1 in a closed configuration. As noted above, refrigerator door 126 of refrigerator appliance 100 includes inner wall 150 and outer wall 152. Inner wall 150 generally defines a portion of the interior of fresh food chamber 122 when door 126 is in a closed position. Outer wall 152 is generally opposite inner wall 150 and defines a portion of the exterior of refrigerator appliance 100 when door 126 is in the closed position. Door 126 includes side walls 154 extending between and connecting inner wall 150 and outer wall 152. A foam or other insulating material is disposed between inner wall 150 and outer wall 152 along the transverse direction T, as well as between the side walls 154 along the lateral direction L. For this exemplary embodiment, handle body 210 forms side wall 154 proximate a lateral centerline LC defined by refrigerator appliance 100 orthogonal to the lateral direction L at a center point of the refrigerator appliance 100 along the lateral direction L. As shown in FIG. 4, refrigerator door 128 can be configured in the same or similar manner as refrigerator door 126. Moreover, although not shown in FIG. 4, freezer doors 130, 131 can likewise include inner, outer, and side walls 150, 152, 154 as shown and described for refrigerator door 126.

As further shown in FIG. 4, when refrigerator doors 126, 128 are in a closed position, first recess 222 defined by handle body 210 of refrigerator door 126 and second recess 224 defined by handle body 210 of refrigerator door 128 define an illumination recess 226. Moreover, a gap G is defined between refrigerator door 126 and refrigerator door 128 along the lateral direction L such that when one or more of the light sources of the respective first and second handle lighting assemblies 302, 304 emit light, the light from within the illumination recess 226 escapes through gap G and thus may be visible from an exterior of refrigerator appliance 100 (e.g., FIG. 1). In this manner, the aesthetic appearance and ease of use of refrigerator appliance 100 can be enhanced.

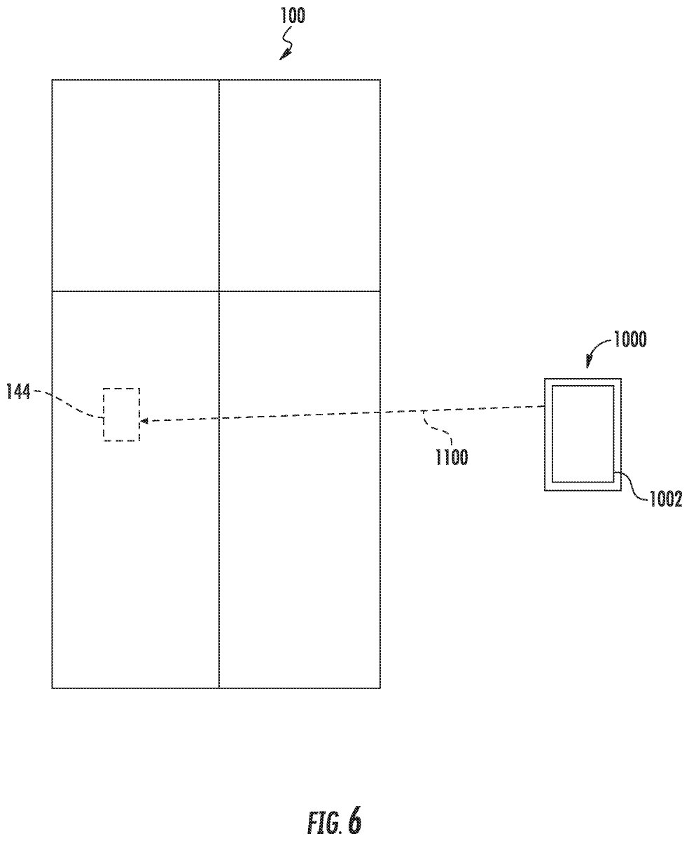

FIG. 5 provides a close up view of Section B of FIG. 4 depicting handle assemblies of refrigerator doors 126, 128, respectively. For this embodiment, the handle lighting assembly disposed within the recess of refrigerator door 126 is a first handle lighting assembly 302 and the handle lighting assembly disposed within the recess of refrigerator door 128 is a second handle lighting assembly 304. As shown in FIG. 5, first handle lighting assembly 302 is disposed within first recess 222 defined by first handle assembly 202 and second handle lighting assembly 304 is disposed within second recess 224 defined by second handle assembly 204.

Each handle lighting assembly 300 includes one or more light sources 352. The light sources 352 can be any suitable type of light source, such as e.g., LEDs, OLEDs, incandescent, halogen, fluorescent, high intensity discharge, a combination of the foregoing, etc. Each lighting assembly 300 may be communicatively coupled with controller 144. For this embodiment, controller 144 is operatively configured to control the lumen intensity of the of light source(s) of each lighting assembly 300. As such, controller 144 can dim or turn off the lighting assemblies 300 in accordance with a set schedule or upon a user input, as described in more detail below.

Each handle lighting assembly 300 includes a lens 342. Moreover, as shown in FIG. 5, for this exemplary embodiment, lens 342 has an arcuate shape.

For each handle assembly 202, 204, a reference plane RP is disposed in a plane coplanar with a front face 360 or point of light source 352. In some embodiments, for example as illustrated in FIG. 5, a film 370 may be provided over the light sources 352 and may be curved towards reference plane RP while lens 342 curves away from reference plane RP. Stated differently, film 370 may be a diverging lens and lens 342 may be a converging lens. In such embodiments, when light source 352 emits light from first handle assembly 202, the light initially passes through film 370. Due to the curvature of film 370, the light diverges as it passes therethrough. The divergence of the light allows the light to spread out over the entire surface of lens 342. Accordingly, efficient use of the lumen intensity of the light emitted from light sources 352 is achieved. The diverging light passes through convex lens 342. Lens 342 converges or focuses the light at the rear sidewall 228 of the second handle assembly 204. The light may then reflect off of the rear sidewall 228 of the second handle assembly 204 and a portion of the reflected light can exit through gap G. Likewise, when light source 352 emits light from second handle assembly 204, the light may be directed in the same manner as noted above for light emitted from first handle assembly 202. The light escaping through gap G provides refrigerator appliance 100 with illumination originating from the pocket handles of refrigerator appliance 100 (e.g., FIG. 1). In this way, the aesthetic appearance and ease of use of refrigerator appliance 100 can be enhanced.

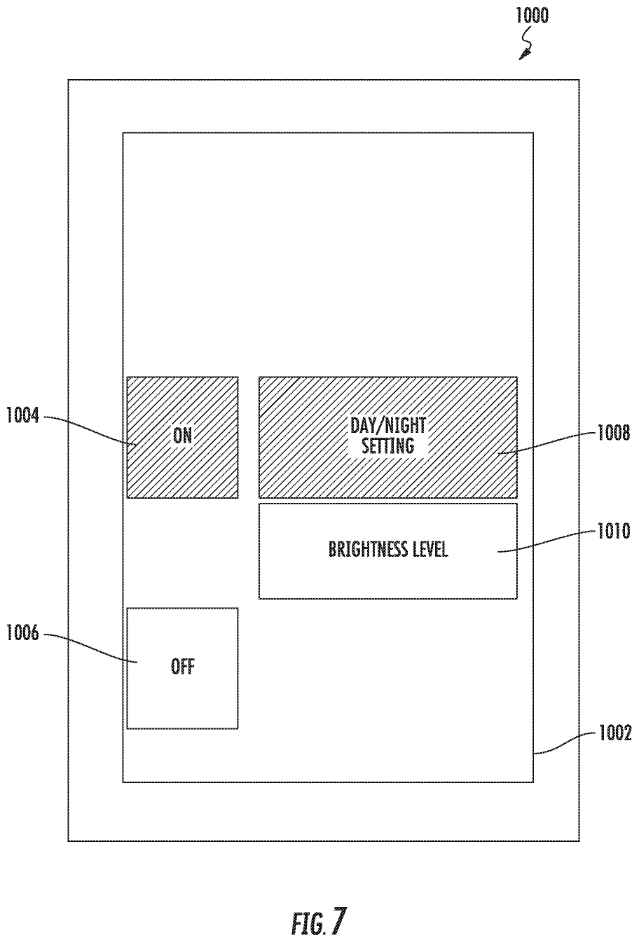

As shown in FIG. 6, the refrigerator appliance 100, and in particular the controller 144 thereof, may be configured to receive a signal 1100 from a remote user device 1000 external to the refrigerator appliance 100. The signal 1100 may, for example, be a short-range radio signal or other suitable wireless signal. For example, the refrigerator appliance 100 may communicate with the remote user interface device 1000 via short-range radio such as BLUETOOTH® or any other suitable wireless network having a layer protocol architecture. As used herein, “short-range” may include ranges of about ten meters or less, up to about one hundred meters. For example, the wireless network may be adapted for short-wavelength ultra-high frequency (UHF) communications in a band between 2.4 GHz and 2.485 GHz (e.g., according to the IEEE 802.15.1 standard). In other examples, the refrigerator 100 and the remote user interface device 1000 may communicate via WIFI®, infrared signals, or any other suitable wireless communication protocol or method. The remote user interface device 1000 may also include a user interface 1002, e.g., a touchscreen, for receiving user inputs.

The remote user interface device 1000 may be a laptop computer, smartphone, tablet, personal computer, wearable device, smart home system, and/or various other suitable devices including a user interface such as a touchscreen display 1002. The remote user interface device 1000 may include a memory for storing and retrieving programming instructions. Thus, the remote user interface device 1000 may provide a remote user interface which may be an additional user interface to the control panel 140. For example, the remote user interface device 1000 may be a smartphone operable to store and run applications, also known as “apps.”

The remote user interface device 1000 may be configured to receive a user input via the user interface 1002, and to send the signal 1100 to the refrigerator appliance 100 based on the received user input. The controller 144 of the refrigerator appliance 100 may be operable to receive the signal 1100 from the remote user interface device 1000 and to operate, e.g., adjust one or more operating parameters of, the auxiliary light, e.g., dispenser light 146 and/or handle light 300 as described above, based on the received signal 1100 from the remote user interface device 1000.

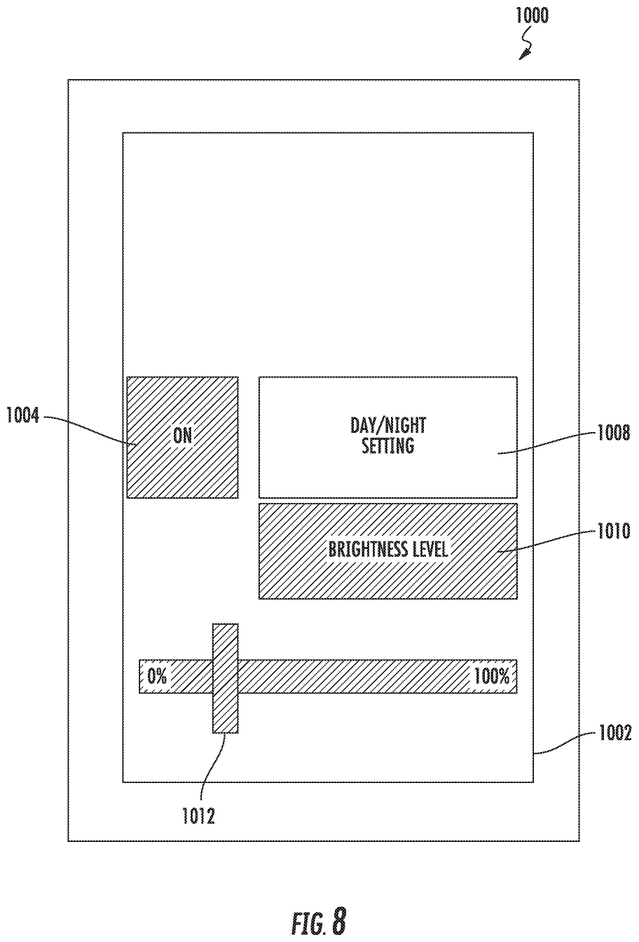

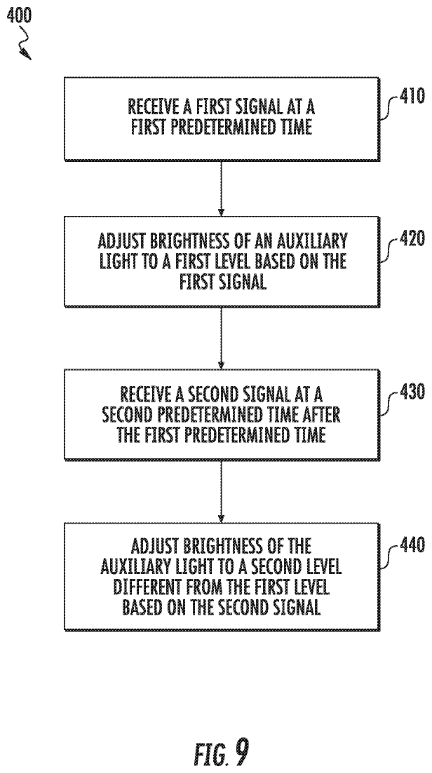

FIG. 7 illustrates an exemplary configuration of the user interface 1002 of the remote user interface device. As shown, the user interface includes an ON input 1004 and an OFF input 1006. In FIGS. 7 and 8, the ON input 1004 is shaded to indicate that it is active. For example, a portion of the touchscreen 1002 may be illuminated to indicate the active or selected input, as shown by shading in FIGS. 7 and 8. In various embodiments, the remote user interface device 1000 may send a signal to the controller 144 of the refrigerator 100 based on a user's selection of one or more inputs on the user interface 1002 of the remote user interface device 1000, and the signal may be indicative of and/or may correspond to the selected input. For example, when a user touches the ON input 1004, the remote user interface device 1000 may send a signal to the controller 144, the controller 144 may receive the signal, and the controller 144 may then turn the auxiliary light, e.g., handle light 300 and/or dispenser light 146, ON based on the received signal.

When the ON input 1004 is selected, the user interface 1002 may then provide additional inputs, such as the Day/Night input 1008 and the Brightness Level input 1010 illustrated in FIG. 7. In at least some embodiments, the remote user interface device 1000 may be configured to receive a user input or selection via one of the inputs 1008 and 1010 after receiving or detecting a user selection of the ON input 1004. As illustrated in FIG. 7, the Day/Night input 1008 has been selected and/or is activated, which the user interface 1002 may confirm by illuminating or otherwise highlighting the Day/Night input 1008, e.g., as shown by shading in FIG. 7.

The Day/Night input 1008 may correspond to an automatic operating mode. For example, the automatic operating mode may include one or more threshold times and corresponding brightness settings for the auxiliary light based on the time of day. For example, the remote user interface device 1000 may be configured to receive or determine a first predetermined time of day, e.g., a morning threshold, and a second predetermined time of day, e.g., an evening threshold, on the user interface 1002, and may automatically send signals to the refrigerator appliance 100 at the predetermined times of day. For example, the morning threshold may be six o'clock (6:00) AM, and the remote user interface device 1000 may send a signal 1100 to the refrigerator appliance 100 automatically when the remote user interface device 1000 determines that the time of day is equal to the morning threshold, e.g., at six o'clock AM. The signal 1100 sent at the morning threshold may correspond to or indicate a first predetermined brightness level, e.g., a day brightness setting, and the controller 144 of the refrigerator appliance 100 may receive such signal and adjust the brightness of the auxiliary light, e.g., dispenser light 146 and/or handle light 300, based on the received signal. Also by way of example, the evening threshold may be eight o'clock (8:00) PM. Similar to the morning threshold, the remote user interface device 1000 may send a second signal 1100 to the controller 144 at the evening threshold, whereupon the controller 144 receives the second signal 1100 and adjusts the brightness of the auxiliary light to a second predetermined level, e.g., a night setting.

FIG. 8 illustrates an exemplary configuration of the user interface 1002 when a manual operation mode is active, e.g., when the Brightness Level input 1010 has been selected. In the manual operation mode, the remote user interface device 1000 may send the signal 1100 immediately after determining a brightness level setting via the user interface 1002, rather than sending the signal at one or more predetermined times, as described above. For example, the brightness level setting may be determined by a brightness input 1012. In the example embodiment illustrated by FIG. 8, the brightness input 1012 is a slider input, where the brightness level setting may be a percentage value within a range from zero percent (0%) brightness to one hundred percent (100%) brightness. In some embodiments, any value from zero percent (0%) to one hundred percent (100%) may be selectable. In other embodiments, a smaller number of brightness levels may be selectable, such as a low level, a medium level, and a high level. The low level may be between about five percent (5%) and about thirty-five percent (35%) brightness, such as about twenty percent (20%) brightness. The medium level may be between about thirty percent (30%) brightness and about eighty percent (80%) brightness, such as about fifty percent (50%) brightness. The high level may be between about sixty-five percent (65%) brightness and about one hundred percent (100%) brightness, such as about ninety percent (90%) brightness. In embodiments where the high level is less than one hundred percent (100%) brightness, a max level corresponding to about one hundred percent (100%) brightness may also be provided. In other embodiments, only two levels may be selectable, such as a low level and a high level. In further embodiments, five or more levels may be selectable.

Where the brightness of the auxiliary light, e.g., dispenser light 146 and/or handle light 300, is adjustable based on signals 1100 from the remote user interface device 1000, the brightness of the auxiliary light may thereby be independent of an ambient light level. For example, the refrigerator appliance 1000 may not include an ambient light sensor. Omitting an ambient light sensor may reduce the cost of the refrigerator appliance 100 and provide a more aesthetically pleasing appearance to the refrigerator appliance 100. For example, the control panel 140 need not include an aperture for the ambient light sensor, providing a smoother and more consistent look to the surface, e.g., touchscreen surface, of the control panel 140. Additionally, the control panel 140 and controller 144 may be simplified in that a clock or means of monitoring time, e.g., downloading date and time data from the interne or receiving a time input at the control panel 140, may be omitted where the remote user interface 1000 provides appropriate signals 1100 at the desired times of day.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of operating a refrigerator appliance, the refrigerator appliance including a cabinet, a door rotatably attached to the cabinet, a pocket handle integrally formed in a recess in the door, and an auxiliary light positioned within the recess, the method comprising:
receiving a signal from a remote device at a predetermined time of day; and
adjusting a brightness of the auxiliary light of the refrigerator appliance based on the received signal, whereby an exterior of the cabinet is illuminated by reflected light originating from the auxiliary light through a gap.

2. The method of claim 1, wherein the brightness of the auxiliary light is independent of an ambient light level.

3. The method of claim 1, wherein the step of adjusting the brightness comprises adjusting the brightness to a predetermined level.

4. The method of claim 3, wherein the predetermined level is one of a low level, a medium level, or a high level.

5. The method of claim 3, wherein the predetermined level is a percentage value within a range from zero percent brightness to one hundred percent brightness.

6. The method of claim 1, wherein the signal is a first signal received at a first predetermined time of day, and the step of adjusting the brightness comprises adjusting the brightness to a first predetermined level, further comprising receiving a second signal at a second predetermined time of day and adjusting the brightness of the auxiliary light to a second predetermined level based on the second signal.

7. A method of operating a refrigerator appliance, the refrigerator appliance including a cabinet, a door rotatably attached to the cabinet, a pocket handle integrally formed in a recess in the door, and an auxiliary light positioned within the recess, the method comprising:
determining a brightness level setting of the auxiliary light on a user interface of a remote user device;
determining a time of day threshold on the user interface of the remote user device;
sending a signal from the remote user device to a controller of the refrigerator appliance at the time of day threshold, the controller in operative communication with the auxiliary light; and
adjusting a brightness of the auxiliary light to the determined brightness level setting with the controller of the refrigerator appliance based on the received signal, whereby an exterior of the cabinet is illuminated by reflected light originating from the auxiliary light through a gap.

8. The method of claim 7, wherein the step of sending the signal is performed immediately after the step of determining the brightness level setting.

9. (canceled)

10. The method of claim 7, wherein the time of day threshold is a morning threshold, further comprising determining an evening threshold on the user interface of the remote user device, wherein the determined brightness level setting is a day brightness setting, and the signal is a first signal, wherein the steps of sending the first signal and adjusting the brightness based on the first signal are performed at the morning threshold, the method further comprising determining a night brightness level setting on the user interface of the remote user device, sending a second signal from the remote user device to the controller of the refrigerator device at the evening threshold, and adjusting the brightness of the auxiliary light to the night brightness level setting with the controller of the refrigerator appliance based on the received second signal.

11. The method of claim 7, wherein the brightness level setting is one of a low level, a medium level, or a high level.

12. The method of claim 7, wherein the brightness level setting is a percentage value within a range from zero percent brightness to one hundred percent brightness.

13. The method of claim 7, wherein the brightness of the auxiliary light is independent of an ambient light level.

14. A refrigerator appliance, comprising:
a cabinet;
a door rotatably connected to the cabinet;
a pocket handle assembly integrally formed with the door and having a handle body defining a recess in the door;
a dispenser assembly comprising a control panel;
an auxiliary light positioned within the recess in the door, the auxiliary light positioned and configured to indirectly illuminate an exterior of the cabinet by light originating from the auxiliary light and reflected through a gap;
a controller in operative communication with the control panel and the auxiliary light, the controller configured for:
receiving a signal from a remote device at a predetermined time of day; and
adjusting a brightness of the auxiliary light based on the received signal.

15. The refrigerator appliance of claim 14, wherein the auxiliary light is positioned within a dispenser recess of the dispenser assembly.

16. The refrigerator appliance of claim 14, wherein the auxiliary light is a handle light in optical communication with the recess of the handle body.

17. The refrigerator appliance of claim 14, wherein the controller is configured to adjust the brightness of the auxiliary light to one of a low level, a medium level, or a high level.

18. The refrigerator appliance of claim 14, wherein the controller is configured to adjust the brightness of the auxiliary light to within a range from zero percent brightness to one hundred percent brightness.

19. The refrigerator appliance of claim 14, wherein the refrigerator appliance does not include an ambient light sensor.
